(19) United States
(12) Patent Application Publication
(10) Pub. No.: US 2023/0110935 A1
(43) Pub. Date: Apr. 13, 2023

(54) COAXIAL CONNECTOR ASSEMBLIES

(71) Applicant: CommScope Technologies LLC, Hickory, NC (US)

(72) Inventors: MuLan Huang, Suzhou (CN); Jien Zheng, Suzhou (CN); ZhaoHui Liu, Suzhou (CN); Chengcheng Tang, Suzhou (CN)

(21) Appl. No.: 17/822,889

(22) Filed: Aug. 29, 2022

Related U.S. Application Data
(60) Provisional application No. 63/254,583, filed on Oct. 12, 2021.

(51) Int. Cl. H01R 24/50; H01R 12/75; H01R 12/57

(52) U.S. Cl. CPC H01R 24/50; H01R 12/75; H01R 12/57; H01R 2103/00

(57) ABSTRACT

A board-to-board connector assembly includes: a coaxial cable portion including an inner conductor, a dielectric layer circumferentially overlying the inner conductor, and an outer conductor circumferentially overlying the dielectric layer; a printed circuit board (PCB); a first connector mounted to the PCB, the first connector including a first inner contact in electrical contact with the inner conductor, and a first outer contact in electrical contact with the outer conductor; and a second connector having a second inner contact in electrical contact with the inner conductor and a second outer contact in electrical contact with the outer conductor. At least one of the first outer contact and the second outer contact is in electrical contact with the outer conductor via a conductive gasket.

### RELATED APPLICATION

The present application claims priority from and the benefit of U.S. Provisional Patent Application No. 63/254,583, filed Oct. 12, 2021, the disclosure of which is b=hereby incorporated herein by reference in full.

### FIELD OF THE INVENTION

The present invention relates generally to wireless communications. In particular, the present invention relates to improvements in wireless base station antenna and radio deployments.

### BACKGROUND OF THE INVENTION

One known wireless radio network system that may be mounted at the top of the tower comprises a remote radio unit (RRU) and a separate antenna. These components are mounted in separate locations and often are cabled together using jumper cables to pass radio frequency (RF) signals between them. In other installations, the RRU may be mounted on the antenna and the RRU and the antenna have printed circuit boards (PCBs) (typically disposed parallel to each other) on which arrays of coaxial connectors are mounted that may plug into each other. So-called “board-to-board” connectors (B2B) may extend between the PCBs to interconnect the connectors on each PCB. Similarly, either an RRU or an antenna may be connected with a filter using a similar type of connector, although often the filter does not a PCB on which the connector mounts. As used herein, the term “B2B” connector is intended to include both situations in which the connector mounts to PCBs at each end and in which the connector mounts at one end to a PCB of an antenna or RRU and at the other end to a filter.

As can be imagined, the tolerances of the PCBs may require that some “float” (both axially and radially) be possible for the B2B connectors in order for them to connect fully. As such, it may be desirable for B2B connectors to have floating capability. It may also be desirable for the manufacture of B2B connectors to provide flexibility for the production of different sizes and lengths of B2B connectors.

### SUMMARY OF THE INVENTION

As a first aspect, embodiments of the present invention are directed to a connector assembly. The assembly comprises: a coaxial cable portion including an inner conductor, a dielectric layer circumferentially overlying the inner conductor, and an outer conductor circumferentially overlying the dielectric layer; a printed circuit board (PCB); a first connector mounted to the PCB, the first connector including a first inner contact in electrical contact with the inner conductor, and a first outer contact in electrical contact with the outer conductor; and a second connector having a second inner contact in electrical contact with the inner conductor and a second outer contact in electrical contact with the outer conductor. At least one of the first outer contact and the second outer contact is in electrical contact with the outer conductor via a conductive gasket.

As a second aspect, embodiments of the present invention are directed to a connector assembly comprising: a coaxial cable portion including an inner conductor, a dielectric layer circumferentially overlying the inner conductor, and an outer conductor circumferentially overlying the dielectric layer; a printed circuit board (PCB); a first connector mounted to the PCB, the first connector including a first outer contact in electrical contact with the outer conductor; and a second connector having a second inner contact in electrical contact with the inner conductor and a second outer contact in electrical contact with the outer conductor. At least one of the first outer contact and the second outer contact is in electrical contact with the outer conductor via a conductive gasket. The inner conductor is electrically directly connected to the PCB.

### BRIEF DESCRIPTION OF THE FIGURES

FIG. 1A is an end view of two printed circuit boards of an antenna and an RRU showing a plurality of coaxial B2B connectors extending therebetween.

FIG. 1B is an end view of a filter with a coaxial B2B connector attached thereto.

FIG. 2 is an exploded side section view of a coaxial B2B connector assembly according to embodiments of the invention.

FIG. 3 is a side section view of a length of coaxial cable for the B2B connector assembly of FIG. 2 with a surface mount inner contact attached.

FIG. 4 is a side section view of the assembled connector assembly of FIG. 2.

FIG. 5 is an exploded side section view of a coaxial B2B connector assembly according to alternative embodiments of the invention.

FIG. 6 is a side view of a length of coaxial cable for the B2B connector assembly of FIG. 5.

FIG. 7 is a side view of the assembled connector assembly of FIG. 5.

FIG. 8 is an exploded side section view of a coaxial B2B connector assembly according to further embodiments of the invention.

FIG. 9 is a side section view of a length of coaxial cable for the B2B connector assembly of FIG. 8 with two conductive gaskets positioned thereon.

FIG. 10 is a side section view of the assembled connector assembly of FIG. 9.

FIG. 11 is an exploded side section view of a coaxial B2B connector assembly according to yet further embodiments of the invention.

FIG. 12 is a side section view of the assembled connector assembly of FIG. 11.

FIG. 13 is a side section view of an assembled connector assembly according to further embodiments of the invention.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout and different embodiments of like elements can be designated using a different number of superscript indicator apostrophes (e.g., 10′, 10″, 10′″).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

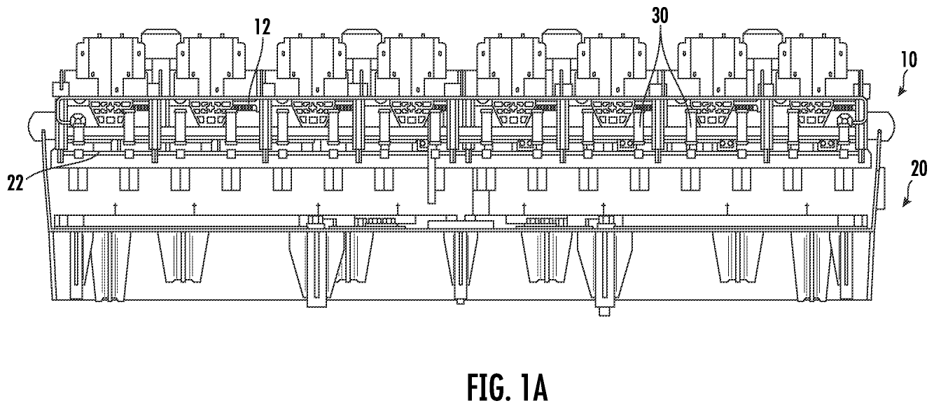

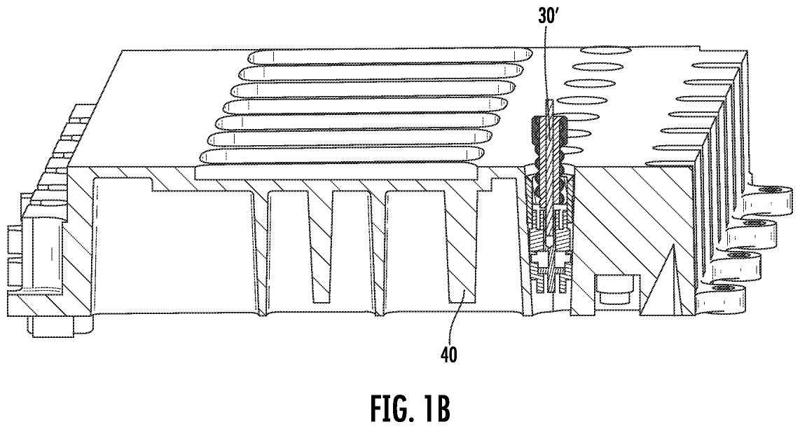

Referring now the drawings, FIG. 1A is an end view of an antenna 10 and a remote radio unit (RRU) 20. As can be seen in FIG. 1A, the antenna 10 includes a printed circuit board (PCB) 12 with a number of locations for connectors, and the RRU 20 includes a PCB 22 that also includes a number of locations for connectors. In FIG. 1A, the connectors 30 shown therein are coaxial B2B connectors. FIG. 1B shows a filter 40 with a B2B connector 30′ mounted therein. Although not shown in FIG. 1B, the upper end of the connector 30′ would be mounted to the PCB of an antenna (such as the PCB 12 of the antenna 10) or of an RRU (such as the PCB 22 of the RRU 20). The discussion that follows will focus on different configurations and embodiments for the coaxial B2B connector assemblies, with the understanding that the discussions of the coaxial B2B connector assemblies can be employed in the manner shown in FIG. 1 for the connectors 30, 30′.

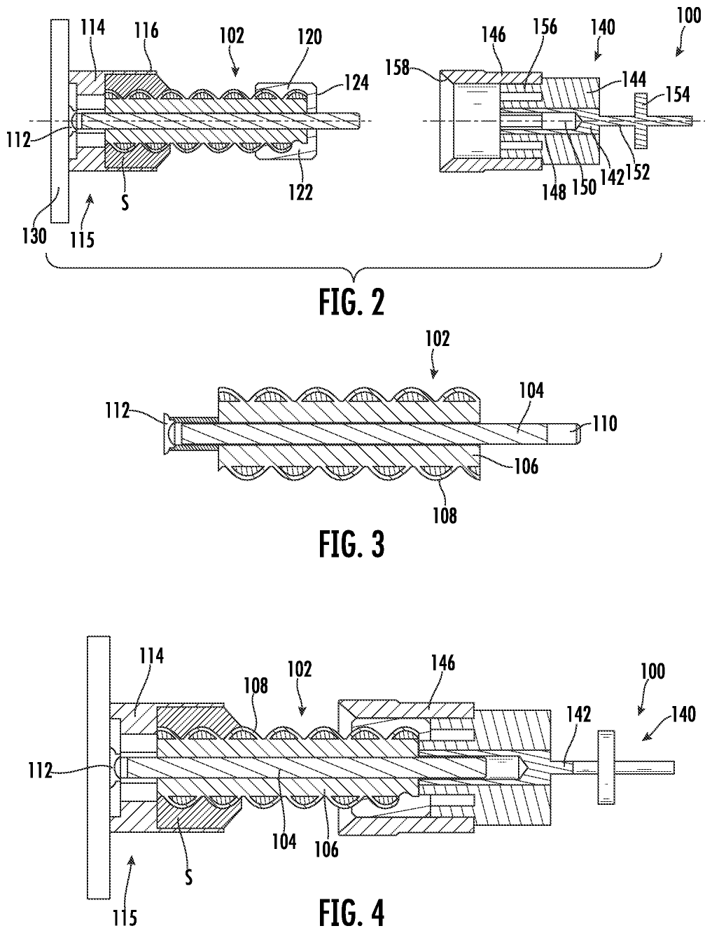

Referring now to FIGS. 2-4, a coaxial B2B connector assembly 100 is shown therein. The connector assembly 100 includes a short coaxial cable portion 102 that has an inner conductor 104, a surrounding dielectric layer 106, and an outer conductor 108. The outer conductor 108 is illustrated as being corrugated in a helical manner, but also may be annularly corrugated, smooth, or braided. As shown in FIG. 3, at one end the inner conductor 104 has an end portion 110 that extends beyond the dielectric layer 106 and the outer conductor 108. At the opposite end, the inner conductor 102 is inserted into an inner contact 112 of a surface mount (SMT) connector 115.

As shown in FIGS. 2 and 4, the inner contact 112 is attached to a surface mount contact of a PCB 130 (in some embodiments, this attachment is achieved via soldering). An outer contact 114 of the SMT connector 115 is also mounted to a surface mounted contact of the PCB 130, with the end of the outer conductor 108 fitting within the outer contact 114. A ring 116 of the outer contact 114 is attached to the outer conductor 108 via soldering (represented by S in FIGS. 2 and 4). If the inner contact 112 is also attached to the PCB 130 via soldering, in some embodiments both the soldering of the inner contact 112 to the PCB 130 and the soldering of the outer conductor 108 to the outer contact 114 may performed in the same soldering operation.

At its opposite end, the coaxial cable portion 102 is inserted into an annular conductive gasket 120. The conductive gasket 120 is formed of a resilient material, such as silicone rubber, that is electrically conductive (e.g., it may include conductive fillers, such as copper, aluminum, silver, graphite, nickel-plated silver, nickel-plated graphite, silver-coated copper and/or silver coated aluminum, and/or combinations of these filler materials). The gasket 120 includes corrugations 122 on its inner surface that can mate with the corrugations of the outer conductor 108. In the illustrated embodiment, the gasket 120 also includes a radially-inward lip 124 that partially overlies the free end of the outer conductor 108.

As shown in FIGS. 2 and 4, the end of the coaxial cable portion 102 and the gasket 120 are inserted into a press-in connector 140 (suitable for attachment to a filter, such as the filter 40 of FIG. 1B). The press-in connector 140 includes an inner contact 142 and an outer contact 146 that are separated by a dielectric layer 144. The inner contact 142 has fingers 148 that surround a receptacle 150 that receives the end portion 110 of the inner conductor 104. At its opposite end, the inner contact 142 includes a post 152 that is encircled by a stop 154. The post 152 is pressed into (or soldered to some embodiments) inner components of the filter (not shown in FIGS. 2 and 4). The dielectric layer 144 has fingers 156 that enable it to slip into and remained fixed relative to the outer contact 146. The outer contact 146 encircles the gasket 120. The inner diameter of the outer contact 146 is sized to radially compress the gasket 120, thereby forming an interference fit with the gasket 120 and forcing the gasket 120 onto the outer conductor 120. The outer contact 146 has a beveled edge 158 that encourages the gasket 120 to slip into place during insertion; in some embodiments, the gasket 120 abuts the fingers 156 of the dielectric layer 144.

The coaxial connector assembly 100 is constructed by mounting the outer contact 114 and the inner contact 112 of the SMY connector 115 on the PCB 130, and soldering the outer conductor 108 to the outer contact 114. The press-in connector 140 can then be slid into place on the coaxial cable portion 102, with the gasket 120 being forced into the outer contact 146 and the tip 110 being forced into the receptacle 150.

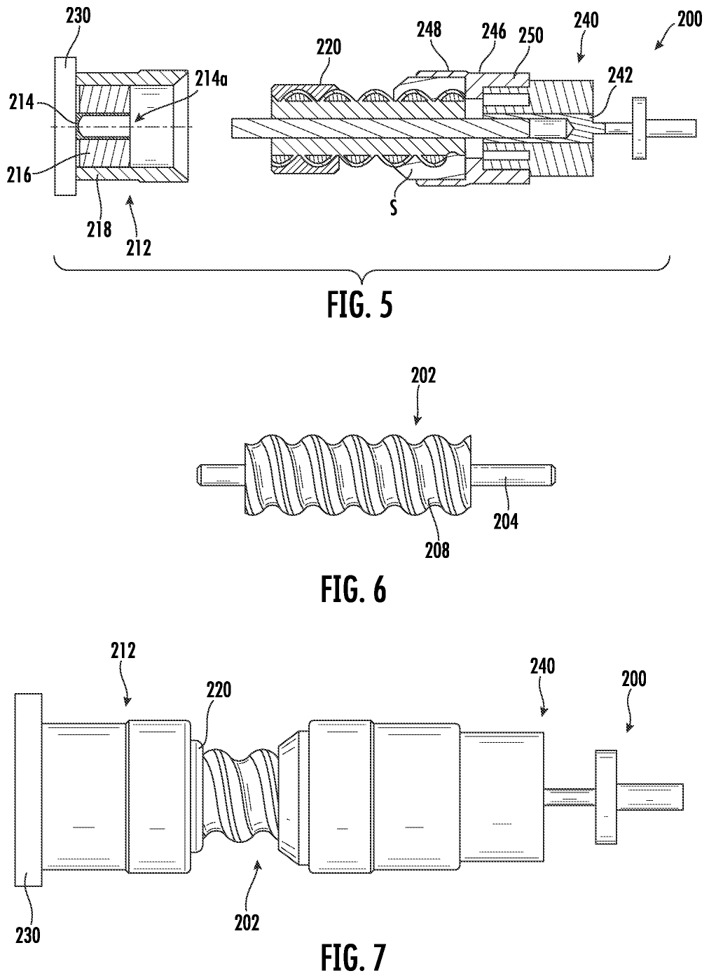

Referring now to FIGS. 5-7, another coaxial B2B connector assembly, designated broadly at 200, is shown therein. As shown in FIG. 6, the assembly 200 has a coaxial cable portion 202 that is similar to the coaxial cable portion 102 described above, but the coaxial cable portion 202 does not have an inner contact attached thereto. Instead, as shown in FIG. 5, an SMT connector 212 with an inner contact 214, a dielectric layer 216, and an outer contact 218 is mounted to the PCB 230. The inner contact 214 has a receptacle 214a that receives the inner conductor 204. A conductive gasket 220 encircles the end of the outer conductor 208, then fits within (typically via an interference fit) the outer contact 218. Thus, the coaxial cable portion 202 can be slipped into and connected with the SMT connector 212 without the need for soldering of the SMT connector 212 to the coaxial cable portion 202.

At its opposite end, the coaxial cable portion 202 is attached to a press-in coaxial connector 240 that has an inner contact 242 that is similar to the inner contact 142, and a dielectric layer 244 that is similar to the dielectric layer 144. An outer contact 246 of the press-in connector 240 has a proximal portion 248 that encircles the end of the outer conductor 208, and is soldered thereto. A distal portion 250 of the outer contact 246 receives the fingers 252 of the dielectric layer 244.

The assembly 200 can be constructed by mounting the connector 212 on the PCB 230, and by inserting the inner conductor 204 into the inner contact 242 of the press-in connector 240 (such that the dielectric layer 244 fits within the distal portion 250). The outer conductor 208 is then soldered (see S in FIG. 5) to the proximal portion 248 of the press-in connector 240. The gasket 220 is positioned on the outer conductor 208, and the subassembly of the coaxial cable portion 202 and the connector 240 is then inserted into the SMT connector 212, such that the inner conductor 204 is received in the receptacle 214a of the inner contact 214, and the gasket 220 is compressed into the outer contact 218.

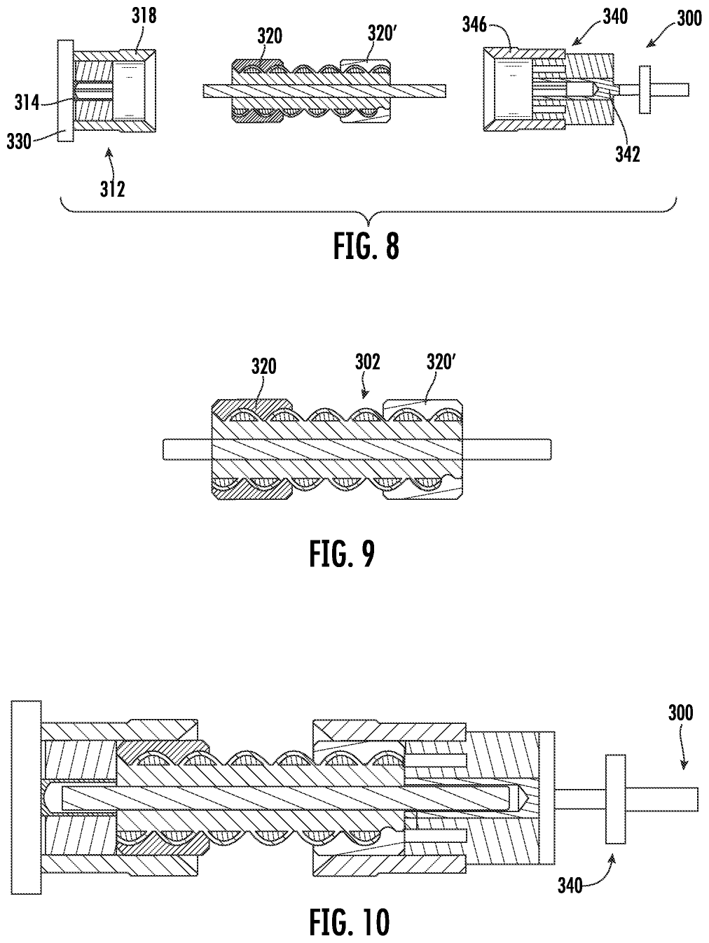

Referring now to FIGS. 8-10, another coaxial B2B connector assembly, designated broadly at 300, is shown therein. As shown in FIG. 9, the assembly 300 has a coaxial cable portion 302 that is similar to the coaxial cable portion 202 described above. The assembly 300 relies on two conductive gaskets 320, 320′ that encircle the ends of the coaxial cable portion 302. An SMT connector 312 mounted to the PCB 330 is similar to the SMT connector 212, and a press-in connector 340 is similar to the press-in connector 140. The gaskets 320, 320′ fit within the outer contacts 318, 346, respectively, and the inner contacts 314, 342 receive the free ends of the inner conductor 304.

Construction of the assembly 300 commences with the attachment of the SMT connector 312 to a PCB 330. The coaxial cable portion 302, with the gasket 320 encircling one end of the outer conductor 308, is inserted into the outer contact 318, and the press-in connector 340 is slipped over the gasket 320′ at the opposite end of the coaxial cable portion 302. Thus, the assembly 300 can be constructing with no soldering steps for attachment of the coaxial cable portion 302 to either of the connectors 312, 340.

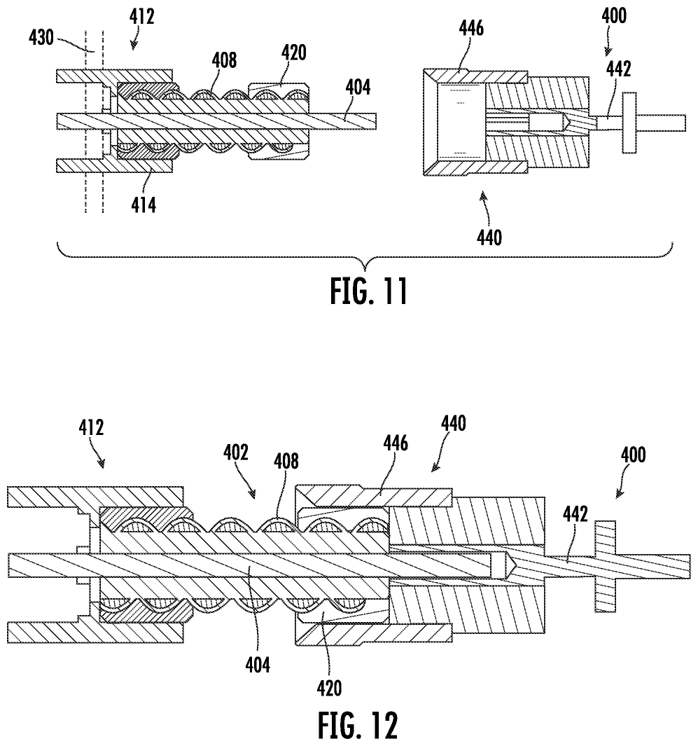

Referring now to FIGS. 11 and 12, another coaxial B2B connector assembly, designated broadly at 400, is shown therein. The assembly 400 has a coaxial cable portion 402 that is similar to the coaxial cable portion 102 described above, but the coaxial cable portion 402 does not have an inner contact attached thereto. The assembly 400 also includes a press-in connector 440 that is similar to the press-in connector 140. However, the assembly 400 includes an SMT connector 412 that has only an outer contact 414, and that is configured to be mounted on a “through-hole” PCB 430. Instead of using an inner contact as is the case with the prior embodiments, in the assembly 400 the inner conductor 404 of the coaxial cable portion 402 makes direct contact with the PCB 430 via a through hole in the PCB 410. The outer conductor 408 of the coaxial cable portion 402 is soldered to the outer contact 414. At the opposite end of the coaxial cable portion 402, the press-in connector 440 is mounted as described above for the assembly 100: namely, the outer conductor 408 is connected to the outer contact 446 via a conductive gasket 420, and the inner conductor 404 is press-fit into the inner contact 442. Because of the limited number of parts and assembly steps, this embodiment may be inexpensive to produce.

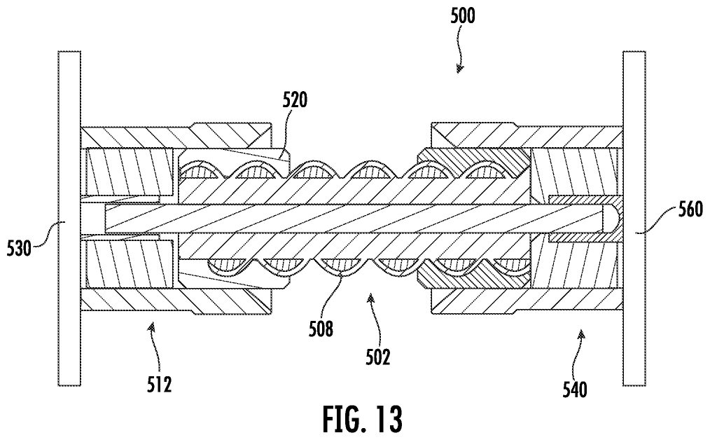

Referring now to FIG. 13, another B2B connector assembly, designated generally at 500, is shown therein. The assembly 500 is similar to the assembly 200 above, with a coaxial cable portion 502 and an SMT connector 512 mounted on a PCB 530 that is connected to the outer conductor 508 of the coaxial cable portion 502 via a conductive gasket 520. However, at the opposite end the coaxial cable portion 502 is attached to a second SMT connector 540 via soldering in the manner shown for attaching the SMT connector 212 to the coaxial cable portion 202. The SMT connector 540 is then mounted to a PCB 560. This arrangement may be employed to connect the PCBs of an antenna and an RRU.

It should be understood that any of the arrangements shown and discussed above may be modified for use with either one SMT connector and one press-in or soldered connector, or alternatively with two SMT connectors.

For all of the coaxial cable portions 102, 202, 302, 402, 502 the axial length of the outer conductor 108, 208, 308, 408, 508 may be between about 10 and 150 mm. The axial length of the inner conductors 104, 204, 304, 404, 504 may be between about 15 and 160 mm. When the length of the outer conductor is more than about 50 mm, the assemblies may have the capability to flex in the transverse direction to adjust for the tolerances between two PCBs or a PCB and a filter.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A connector assembly, comprising:
a coaxial cable portion including an inner conductor, a dielectric layer circumferentially overlying the inner conductor, and an outer conductor circumferentially overlying the dielectric layer;
a printed circuit board (PCB);
a first connector mounted to the PCB, the first connector including a first inner contact in electrical contact with the inner conductor, and a first outer contact in electrical contact with the outer conductor;
a second connector having a second inner contact in electrical contact with the inner conductor and a second outer contact in electrical contact with the outer conductor;
wherein at least one of the first outer contact and the second outer contact is in electrical contact with the outer conductor via a conductive gasket.

2. The connector assembly defined in claim 1, wherein the first outer contact is in electrical contact with the outer conductor via the conductive gasket, and the second outer contact is electrically connected with the outer conductor via a solder joint.

3. The connector assembly defined in claim 1, wherein the second outer contact is in electrical contact with the outer conductor via the conductive gasket, and the first outer contact is electrically connected with the outer conductor via a solder joint.

4. The connector assembly defined in claim 1, wherein the conductive gasket is a first conductive gasket, wherein the first outer contact is in electrical contact with the outer conductor via the first conductive gasket, and wherein the assembly further comprises a second conductive gasket that electrically connects the second outer contact and the outer conductor.

5. The connector assembly defined in claim 1, wherein the outer conductor is corrugated.

6. The connector assembly defined in claim 1, wherein the conductive gasket comprises silicone rubber.

7. The connector assembly defined in claim 6, wherein the conductive gasket comprises a filler material selected from the group consisting of: copper, aluminum, silver, graphite, nickel-plated silver, nickel-plated graphite, silver-coated copper and silver coated aluminum, and combinations thereof.

8. The connector assembly defined in claim 1, wherein the first connector is surface-mounted to the PCB.

9. The connector assembly defined in claim 1, wherein the second connector is connected to a second PCB.

10. The connector assembly defined in claim 9, wherein the first PCB is mounted in an antenna, and the second PCB is mounted in a remote radio unit.

11. The connector assembly defined in claim 8, wherein the PCB is mounted in an antenna or a remote radio unit, and the second connector is connected to a filter.

12. A connector assembly, comprising:
a coaxial cable portion including an inner conductor, a dielectric layer circumferentially overlying the inner conductor, and an outer conductor circumferentially overlying the dielectric layer;
a printed circuit board (PCB);
a first connector mounted to the PCB, the first connector including a first outer contact in electrical contact with the outer conductor;
a second connector having a second inner contact in electrical contact with the inner conductor and a second outer contact in electrical contact with the outer conductor;
wherein at least one of the first outer contact and the second outer contact is in electrical contact with the outer conductor via a conductive gasket; and
wherein the inner conductor is electrically directly connected to the PCB.

13. The connector assembly defined in claim 12, wherein the second outer contact is in electrical contact with the outer conductor via the conductive gasket, and the first outer contact is electrically connected with the outer conductor via a solder joint.

14. The connector assembly defined in claim 12, wherein the outer conductor is corrugated.

15. The connector assembly defined in claim 12, wherein the conductive gasket comprises silicone rubber.

16. The connector assembly defined in claim 12, wherein the conductive gasket comprises a filler material selected from the group consisting of: copper, aluminum, silver, graphite, nickel-plated silver, nickel-plated graphite, silver-coated copper and silver coated aluminum, and combinations thereof.

17. The connector assembly defined in claim 12, wherein the inner conductor is through-mounted to the PCB.

18. The connector assembly defined in claim 12, wherein the second connector is connected to a second PCB.

19. The connector assembly defined in claim 18, wherein the first PCB is mounted in an antenna, and the second PCB is mounted in a remote radio unit.

20. The connector assembly defined in claim 12, wherein the PCB is mounted in an antenna or a remote radio unit, and the second connector is connected to a filter.
